(19) United States
(12) Patent Application Publication
(10) Pub. No.: US 2023/0216389 A1
(43) Pub. Date: Jul. 6, 2023

(54) IMPROVEMENTS TO THE PERFORMANCE OF AXIAL FLUX GENERATORS

(71) Applicant: TIME TO ACT LIMITED, Hatfield (GB)

(72) Inventor: Hugh-Peter Granville KELLY, Hatfield (GB)

(21) Appl. No.: 17/928,871

(22) PCT Filed: May 28, 2021
(86) PCT No.: PCT/GB2021/051335

§ 371 Date: Nov. 30, 2022

(30) Foreign Application Priority Data
Jun. 1, 2020 (GB) 2008194.9

(51) Int. Cl. H02K 21/24; H02K 1/18; H02K 3/04; H02K 3/47

(52) U.S. Cl. CPC H02K 21/24; H02K 1/182; H02K 3/04; H02K 3/47; H02K 2213/03

(57) ABSTRACT

An axial flux generator comprising: two magnetic annuli; a coil annulus; the magnetic annuli and coil annulus having a common axis; the two magnetic annuli defining a plurality of magnetic fields around the common axis extending across a gap between the two magnetic annuli and the coil annulus having a sequence of coils around the common axis in the gap such that the lines of magnetic flux from the magnetic fields cut the turns of the coils and this induces electric current in the coils as the magnetic annuli are caused to rotate relative to the coil annulus; wherein each coil has a shape in a plane perpendicular to the common axis where a first position and a second position on the shape are at a radial distance from the common axis that is greater than the radial distance from the common axis of a radially innermost position of the shape by an amount that is at least 60% of the difference in radial distance from the common axis between the radially innermost position and a radially outermost position of the shape and the first position and second position are on opposite sides of the shape at a radial location where the shape has a maximum dimension in a direction perpendicular to the radial direction, and a portion of the shape that is radially outward from the first and second positions is within an area bounded by an inner line and an outer line between the first and second positions, the inner line and the outer line both being radially outward from the first and second positions and having a radius that is 0.625 times the maximum dimension of the shape in the direction perpendicular to the radial direction, and the outer line being longer than the inner line.

### CROSS-REFERENCE TO RELATED APPLICATIONS

This application represents the national stage entry of PCT International Patent Application No. PCT/GB2021/051335 filed on May 28, 2021 and claims priority to Great Britain Patent Application No. 2008194.9 filed on Jun. 1, 2020. The contents of each of these applications are hereby incorporated by reference as if set forth in their entirety herein.

### DESCRIPTION

The following disclosure relates to improvements in the performance of axial flux generators. In particular, it relates to improvements in the stators and the permanent magnet rotors used in the type of generator disclosed in my co-pending patent applications GB2520516 & GB2532478 & GB2538516 & WO2018/100396.

### BACKGROUND

In such a generator, a series of spaced colinear annular rotor plates, bearing permanent magnets, sandwiches a series of coil-carrying colinear annular stators. Lines of magnetic flux cross the gaps between the facing rotors. Upon rotation of the rotors relative to the stators, the lines of flux cut the turns of the stator coils and electromotive forces are generated therein.

It is a common objective for any generator to convert as much as possible of the mechanical energy provided thereto into electricity. In this respect, optimising the geometrical design of the stator coils is a key aspect. The more effectively the turns of the stator coils are cut by the lines of magnetic force provided by the rotors, the greater the electrical output.

A typical design of stator coil, seeking this objective, is one in which its lateral sides, or at least the major portion of them, lie substantially parallel to a common radius of the generator's rotor or stator. The purpose being to ensure the traversing lines of magnetic flux provided by the rotors cut the turns of the coil orthogonally and thereby induce within them, in accordance with Fleming's right hand rule, the maximum possible emf.

### SUMMARY

The present disclosure relates to an axial flux generator comprising: two magnetic annuli; a coil annulus; the magnetic annuli and coil annulus having a common axis; the two magnetic annuli defining a plurality of magnetic fields around the common axis extending across a gap between the two magnetic annuli and the coil annulus having a sequence of coils around the common axis in the gap such that the lines of magnetic flux from the magnetic fields cut the turns of the coils and this induces electric current in the coils as the magnetic annuli are caused to rotate relative to the coil annulus; wherein each coil has a shape in a plane perpendicular to the common axis where a first position and a second position on the shape are at a radial distance from the common axis that is greater than the radial distance from the common axis of a radially innermost position of the shape by an amount that is at least 60% of the difference in radial distance from the common axis between the radially innermost position and a radially outermost position of the shape and the first position and second position are on opposite sides of the shape at a radial location where the shape has a maximum dimension in a direction perpendicular to the radial direction, and a portion of the shape that is radially outward from the first and second positions is within an area bounded by an inner line and an outer line between the first and second positions, the inner line and the outer line both being radially outward from the first and second positions and having a radius that is 0.625 times the maximum dimension of the shape in the direction perpendicular to the radial direction, and the outer line being longer than the inner line.

In many prior-art examples, the outer and inner circumferential portions of the coils necessary to conjoin the sides thereof, are formed to be as short as possible, and thereby to lie parallel, or close to parallel with the direction of rotation of the lines of flux. (Such coils are thus close to trapezoidal in profile.) However in such arrangements, emfs can only be induced in the radial side portions of the coil. No lines of flux actually cut the aforesaid circumferentially disposed outer and inner portions. Indeed, their only function is to complete circulating current paths between the generating radial sides of the coil.

Parasitic I²R heat losses occur in those inner and outer portions which, because they are not cut by magnetic flux, provide no contribution whatsoever to the performance of the coil and in fact, on account of the aforesaid losses, detract from it. A specific example is that disclosed in U.S. Pat. No. 7,109,625B1, in which long straight radial sides of stator coils converge to a narrow bend at their inner extent, and at their outer extent, are conjoined by arc sections of some length. This practice is far from ideal. Significant I²R losses occur in these outside portions of its stator windings, resulting in unwanted heat and impeding performance. While many alternative designs take a less rectilinear approach to those upper portions of stator coils (such as coils with a circular shape, see for example WO2018/100396) it has not been appreciated that by combining in a specific alternative configuration optimised rotor magnet and stator coil geometries at the outer and inner extent of the coils, this can lead to an actual increase in output. By far the most significant extent in terms of generation is the outer as this is necessarily greater in length than the inner, and being on the periphery of a generator, also enjoys the greatest rate of change of flux as provided by the rotor permanent magnets.

Another known axial flux machine that fails to address the issue of optimising emf generation at the radially outermost and innermost parts of a coil is disclosed in US 2014/0070638 A1. This document discloses an axial flux machine having coils and magnets, in which only the substantially radially extending lateral portions of the coils are sandwiched between magnets and thus only these portions contribute substantially to emf production. In US 2014/0070638 A1, the outermost and innermost regions of the coils, which link together the radially extending lateral sides, are neglected for emf production and are instead designed with grooves that allow for coils to overlap so that more radially extending lateral sides of coils may be present between the magnets. In other words, in US 2014/0070638, the only consideration governing the shape of the outer and inner parts of the coils is the need for grooves to be present such that the coils may overlap to allow more of the radially extending lateral portions of coils to be packed between magnets. Similarly, JP 2004007917 A discloses a generator in which the outermost and innermost portions of its coils are not sandwiched between magnets and so emf generation in these portions is of no concern. The present disclosure, by contrast to these documents, is concerned with maximising the emf that can be obtained from the outer portion of the coils, which means taking into account the emf generation at the outer extent of the coils as well as the radially extending lateral sides.

The present disclosure is advantageous because when the shape of the coil is in accordance with claim 1 the emf generated in the radially outermost portion of the coil is increased relative to examples in the prior art. Indeed the shape is within 25% of the optimum calculated by the present inventor. An additional advantage is that coil winding is facilitated because the radius of the transition at the first and second positions is greater than in the prior art and coils with small radii are problematic to wind. An advantage is also present over a circular or elliptical coil because by having the widest part of the coil that is more than 60% along the radial length of the coil, the packing efficiency of multiple coils in a sequence of coils as disposed around the common axis is increased, hence maximising the length of wire in the coils which cut the magnetic field for a given rotation and so increasing the generated emf.

The shape of each of the coils is described in terms of the mid position of the width of the coil as illustrated in FIG. 6a by line 60. That is, unless otherwise specified, if a portion of a coil is described as conforming to the shape, it is middle of that portion of the coil which follows said shape.

According to the disclosure, the profile of the outer portion of a stator coil of an axial flux generator, as swept by lines of magnetic force provided by rotor borne permanent magnets on either side thereof, together with the profiling and sizing of the said permanent magnets, are jointly optimised such as to maximise the emf generated in the said outer portion.

In some embodiments, the magnetic annuli each hold a series of permanent magnets around the common axis, the permanent magnets defining the magnetic fields, wherein a radially outermost extent of each of the permanent magnets is no greater than a radially outermost extent of each of the coils.

In some embodiments, the radially outermost extent of each of the permanent magnets reaches at least 10%, preferably at least 30%, more preferably at least 40% and/or at most 100%, preferably at most 80%, more preferably at most 60% across a thickness of the radially outermost extent of the coils, the thickness being the radial distance between inner and outer perimeters of the coil.

In practice, and for reasons of economy both in terms of the weight and cost of the permanent magnets, it can be impractical to furnish even-density magnetic fields as aforesaid. The magnets may be knowingly foreshortened in terms of their radial length. Even though the magnets are foreshortened, some curved flux passes between them lying outside their peripheries. According to a further feature of the disclosure, in this case the exact curved profile of the coil may be modified away from pure semi-circular still to optimise the emf generated by the foreshortened magnets.

In this case, a preferred radial length of permanent magnet is such that the end portion of the permanent magnet reaches substantially half way (i.e. 50%) across the width of the end portion of the stator coil.

In any of the foregoing cases, sophisticated mathematical analysis such as finite element analysis (FEA) can be used to determine the best permanent magnet and coil profiles for any preferred configuration. By mapping at their outer extremities the strength and density of the lines of force between facing rotor magnets, and quantifying the lengths and angles of coil conductors cutting these said lines of force, the precise shaping of the rotor permanent magnets and the portions of coils cut by the flux arising, can be optimised to maximise the power generated.

### BRIEF DESCRIPTION OF DRAWINGS

The disclosure will now be described by way of example only with reference to the accompanying drawings in which:

FIG. 1 shows a side view of an annular stator sandwiched by permanent magnet rotors of an axial flux generator.

FIG. 2 shows in detail a portion of the items of FIG. 1.

FIGS. 3a and b show examples of prior art coils of other axial flux generators.

FIG. 4 shows an idealised arrangement of magnetic field and a stator coil according to the disclosure.

FIG. 5 shows formulae illustrating the realisation of the disclosure.

FIGS. 6a and b. show a specific practical realisation of the disclosure.

FIG. 7 shows the shape of the coils.

FIG. 8 is a magnified view of the first position.

FIG. 9 shows an exploded view of an axial flux generator not in accordance with the present disclosure.

### DETAILED DESCRIPTION OF EMBODIMENTS

In order to facilitate an understanding of the present disclosure, a general description of my original first generator, as disclosed in WO 2015/075456, is first given.

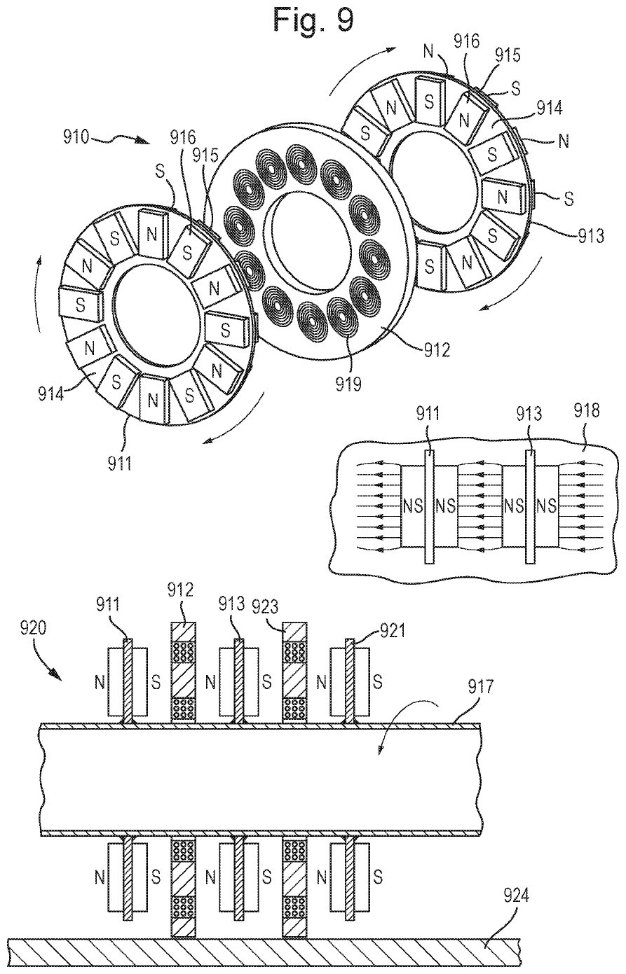

Referring to FIG. 9, the principal components of this first generator 910 are shown in exploded view at 911, 912 and 913 which are stator and armature annuli coaxially mounted for relative rotation around their common axis. 911 and 913 are rotating rotors or armature annuli or magnetic annuli.

Each magnetic annuli 911, 913 comprises a ferromagnetic annulus 914 onto and around each side of which are affixed in attraction permanent magnets 915 and 916 to form a magnetic annulus defining a plurality of magnetic fields around the axis of the rotating rotors 911, 913. In an embodiment, the outward facing polarities of the magnets alternate from north to south around the annulus as shown such that the magnetic fields are of alternating polarity. This allows adjacent magnetic fields to be closely spaced, thereby optimising induced emf for a given generator diameter. The rotors 911 and 913 are each located on a central cylinder 917, but are one magnet pole pitch displaced from their facing neighbours, such that all of the magnets on the rotors are in attraction, and lines of magnetic flux can cross freely all the way across the gap from one rotor disc to the next. This is further illustrated by the inset diagram shown at 918. In an embodiment, the magnetic annuli 911, 913 are magnetically uncoupled from each other (apart from the magnets). This means that there is no magnetic material connecting the magnetic annuli 911, 913 together. The flux crossing the gap, and thus cutting the stator coils, is entirely between facing magnets. This helps concentrate flux across the gap. In other words, no physical magnetic coupling between the magnetic annuli 911, 913 is required in order to generate significant amounts of emf. In an embodiment, each of the stator/armature annuli is self contained, inasmuch that no or substantially no physical magnetic coupling and/or actual magnetic contact is required between them for efficient operation of the generator.

The coil carrying stator annuli or coil annuli 912 are sandwiched between the rotating rotors 911, 913, and are maintained stationary relative to the rotating rotors 911, 913. Each stator annuli 912 carries a series of contiguous, or nearly contiguous, coils 919 in the gap. The circular coils 919 as shown in FIG. 9 are not in accordance with the present disclosure. By contiguous or nearly contiguous is meant a lateral gap between adjacent sides of coils being no more that 10% of their circumferential lateral width. The lateral gap between adjacent sides of coils is defined, for a particular pair of adjacent coils in the sequence of coils, as the shortest straight-line distance (in a plane normal to the common axis) between the surface of one of the coils and the surface of the other coil. The circumferential lateral width of a coil is defined as the length of a straight line that passes through the first position and the second position of the coil and has both of its endpoints on the outer surface of the coil. The two coils that are separated by a lateral gap may have the same circumferential lateral width, but if they do not, then the lateral gap is defined as being no more than 10% of the circumferential lateral width of either of the coils. By restricting the gap between adjacent coils in the sequence of coils in this way, the amount of space in the coil annulus that is occupied by coils and thus contributes to emf production can be advantageously increased, in comparison to a generator having wider gaps between adjacent coils.

In an embodiment, adjacent coils do not overlap in an axial direction, i.e. the coils are non-overlapping in the axial direction. Overlapping of coils in the axial direction requires the gap between adjacent magnetic annuli to be increased to accommodate the overlapping coils, which disadvantageously reduces the mean emf generating capacity of each coil. Overlapping coils could alternatively be designed so that the axial depth of the whole set of coils does not exceed the axial depth of a single coil (as in US 2014/0070638 A1), but this requires the coils to have a complex slotted construction which is difficult to manufacture and assemble. The present embodiment advantageously allows the gap between adjacent magnetic annuli to be kept to a minimum without requiring overly complex assembly of the coils.

In an embodiment, the coils 919 are sited around the stator annulus 912 circumference. The coils 919 may be circularly attached around the common axis as illustrated. The stator annuli 912 are affixed to mounting means (not shown) to maintain them equally spaced in between the armature annuli 911, 913. A generator of modest rating could comprise just two armature annuli 911, 913 sandwiching a single stator annulus 912, or even just one armature annulus 911 and one stator annulus 912, but the arrangement can be repeated for the requisite generator capacity along the full length of the generator, as shown at 920, where 911 and 913 and 921 are rotating magnetic rotors and 912 and 923 are the stator coil annuli. The stator coil annuli 912 and 923 are in this case shown mounted on a portion of an external supporting structure 924.

Although the magnets are shown on the rotating annuli 911, 913 and 921 in fact they could alternatively be mounted on the stator annuli 912 and 923 and the coils 919 be mounted on the rotating (armature) annuli 911, 913 and 921. In this case, suitable commutation means would be required to conduct the generated emf away from the rotors.

The sequence of coils is circularly attached around the common axis such that lines of magnetic flux from the magnetic fields cut the turns of coils 919 and thus induce electric current in the coils 919 as the armature annulus is caused to rotate relative to the stator annulus. In the case of three magnetic annuli 911, 913 and 921, the coils are in the gap between the three magnetic annuli 911, 913 and 921.

The magnetic fields may be provided by permanent magnets or non-permanent magnets such as electromagnets.

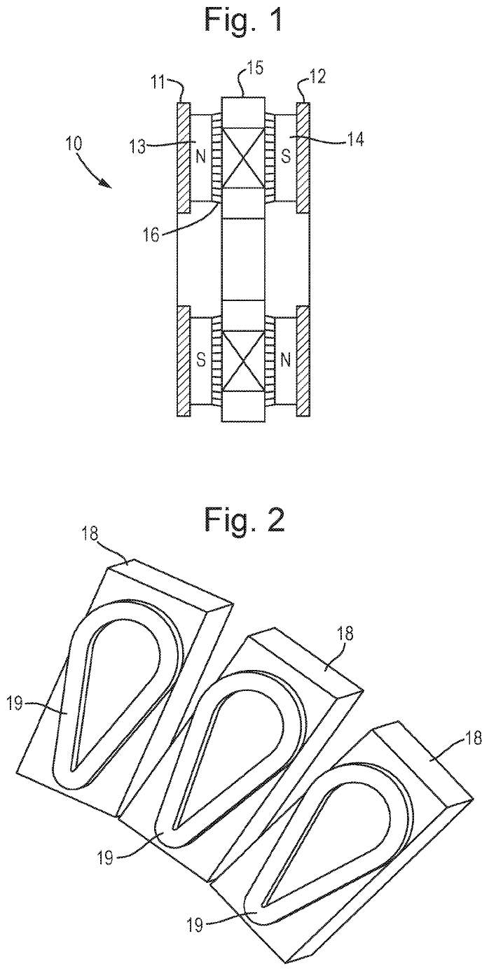

Referring to FIG. 1, the principal components of a generator of the present disclosure are shown in side elevation at 10. Two annular rotors, 11 and 12, bearing permanent magnets 13 and 14 around their inner faces, sandwich an annular coil carrying stator 15. The magnets alternate in polarity around the rotors bearing them, and opposite poles face one another across the air gap. Lines of magnetic force crossing from one rotor to the other are denoted at 16. Means (not shown) cause the rotors to turn relative to the stator thereby inducing emfs in the coils 17 embedded within it.

An exploded view of the stator and a single rotor is shown with reference to FIG. 2. Rotor magnets are shown schematically at 18, and individual coils at 19. In this particular arrangement, the magnets are shown reaching proud at their upper extents over the coils facing them. The upper portions of the coils, namely the portions that connect its left hand conductors to the right hand conductors, are thus within the window of flux crossing the airgap. In addition, as displayed in the drawing, these coil upper portions are substantially semi-circular in shape, for a reason to be expounded hereinafter.

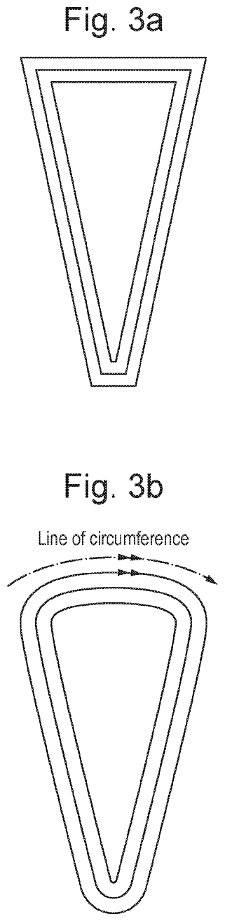

Referring to FIG. 3, alternative coil geometries are shown as adopted by others manufacturing this type of generator. In the example shown in FIG. 3a, the upper portion is shown as connections directly across from one side of the coil to the other. The straight upper portion of FIG. 3a will not be cut to any great extent by the flux lines 16 of FIG. 1, and very little emf would be induced in the upper portion, were such a coil to be embedded in the stator. Suffering even more of the same limitations, is the arrangement shown in FIG. 3b, which is similar to coils disclosed in JP 2004007917 A (see FIGS. 5, 9, 17, 24 and 28 of that document). In this case, the slight curvature, if e.g. following a circumference of the generator, will contribute nothing at all to the generated emf.

In each case, I²R losses occur in these outside portions of the stator windings, resulting in unwanted heat and impeding performance.

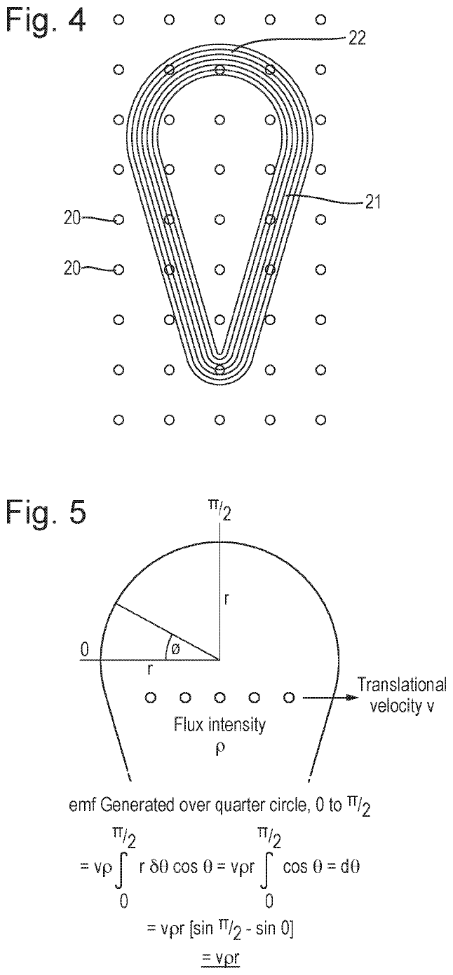

However, and in accordance with the disclosure, forming the connecting portion in a pronounced curve secures a useful generation of emf in this (essential) portion of a coil. This is shown more clearly in FIG. 4, in which lines of flux are shown schematically at 20 and a coil fully enjoying these at 21. The top portion 22 is shown as close to a semicircle, which is shown below to form the optimum shape, but the disclosure is not limited only to the optimum shape, but shapes which are substantially within 25% of the optimum, as will be described below. Also, outer portions with shapes other than portion of circles fall within the disclosure, including but not limited to ellipses. Other example shapes include smooth curves which may even meander. By being positioned within the area, the coils of the coil will inevitably be shaped so as to be cut by lines of magnetic flux (which follow a radial path around the common axis) and will generate more emf than the shape of FIGS. 3a and 3b.

FIG. 5 sets out the situation mathematically. Integrating the emf over one half of the semicircle shows that its effective emf generating conductor length is its radius, r. The same applies of course to the other side. Thus the total emf generating effective conductor length is on average 2r, (=the average diameter of the circle). This is a considerable enhancement. In the case of FIG. 3b, as outlined before, this same distance generates nothing.

It is the case that the total length of conductor is slightly greater compared to the “straight across versions” by a factor of pi/2, but this is inconsequential given the extra emf generated in the effective increased conductor length of 2r.

According to a feature of the disclosure, in one arrangement, the lines of force provided by the permanent magnets are substantially consistent in density over the portion of coil to be swept by them, the profile of the coil is selected to be semi-circular, or close to semi-circular. In this case, theoretically, only the infinitesimally small apex of the coil—lying coaxially to a circle of the stator—will contribute nothing electrically. It can be shown mathematically that given this flux pattern, adopting a circular profile contributes the most emf towards generation and at the least dissipation.

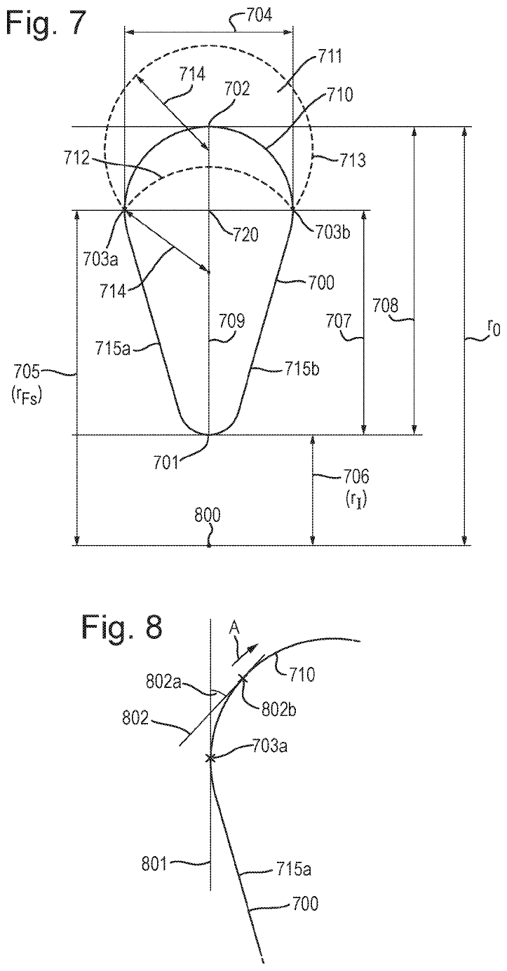

FIG. 7 shows the geometry of the shape 700 of the coils, in a plane perpendicular to the common axis 800, in accordance with the disclosure. The shape comprises a radially innermost position 701 that is the closest point on the shape to the common axis 800, and a radially outermost position 702 that is the farthest point on the shape from the common axis 800. The shape also comprises a first position 703a and a second position 703b, which have a separation 704 in the direction perpendicular to the radial direction of the axial flux generator. The separation 704 is greater than the separation in that direction of any other two points on the shape. In other words, the first position and second position are at a (e.g. any) radial location where the shape has a maximum dimension in a direction perpendicular to the radial direction of the generator.

In other words, at a particular radial distance from the common axis, the shape has a width which may be defined as the linear distance between the two furthest apart points on the shape that coincide with a line that is in the plane of the shape and perpendicular to a radial line which emanates from the common axis and passes through the midpoint of those two furthest apart points. In FIG. 7, the midpoint at a radial distance from the common axis equal to length 705 is shown at 720. As also shown in FIG. 7, the first position 703a and second position 703b are defined to be the points whose separation is the maximum width of the shape. So, the first and second positions being at a radial location where the shape has a maximum dimension in a direction perpendicular to the radial direction of the generator means that the first and second positions are a pair of positions on the boundary of the shape whose separation is a straight line which is perpendicular to a radial line emanating from the common axis and passing through the midpoint of that pair of positions, that line having a length which is greater than or equal to the length of a line defined in this way which separates any other pair of positions on the shape.

The first position 703a and second position 703b are at a radial distance 705 from the common axis 800 that is greater than the radial distance 706 of the radially innermost position 701 from the common axis 800 by an amount 707 that is at least 60% of the difference 708 in radial distance from the common axis between the radially innermost position 701 and the radially outermost position 702. As shown in FIG. 7, the radial distance 705 from the common axis (i.e. radial location) of the first and second positions 703a, 703b is defined to be the minimum linear separation between the common axis and a straight line which passes through both the first and second position. In other words, the radial distance from the common axis (i.e. radial location) of the first and second positions is the linear distance between the common axis and the midpoint of the first and second positions. If the radial distance from the common axis of the first and second position is termed r_{FS}, the radial distance from the common axis to the radially innermost position is termed r_{I}, and the radial distance from the common axis to the radially outermost position is termed r_{O}, then the shape satisfies (r_{O}−r_{FS})/(r_{FS}−r_{I})≤⅔ (r_{FS}, r_{O} and r_{I} are illustrated in FIG. 7). Practically this means that the width of the shape is greatest closer to the radially outermost position than to the radially innermost position.

In some embodiments, the maximum width of the coil occurs at a single radial position, or a range of radial positions that covers no more than 20% of the total radial extent of the shape (the total radial extent being the difference in radial position between the radially outermost position and the radially innermost position). In this embodiment only a single radial location at which the maximum width of the shape occurs needs to fulfil the requirement of being at a radial distance from the common axis that is greater than the radial distance from the common axis of a radially innermost position on the shape by an amount that is at least 60% of the difference in radial position from the common axis between the radially innermost position and a radially outermost position on the shape (such that the pair of farthest apart points on the boundary of the shape at that radial location fulfils the definition of “first position” and “second position” in the present disclosure).

In some embodiments, for every pair of positions on the shape that are at a radial location where the shape has a maximum dimension in a direction perpendicular to the radial direction, the radial distance from the common axis of the midpoint of that pair of positions is greater than the radial distance from the common axis of the radially innermost position of the shape by an amount that is at least 60% of the difference in radial distance from the common axis of between the radially innermost position of the shape and the radially outermost position of the shape. In this embodiment, the first and second positions are defined at any location where the shape has a maximum dimension in a direction perpendicular to the radial direction (i.e. where the shape is widest). In an embodiment, a coil shape has a widest portion which occurs over a range of different radial locations and every part of the widest portion has a width extending between two points which satisfy the definitions of the first and second position (that is, being at a radial distance from the common axis that is greater than the radial distance of the radially innermost position from the common axis by an amount that is at least 60% of the difference in radial distance from the common axis between the radially innermost position and the radially outermost position 702). This embodiment thus does not include, for example, a coil shape having a widest portion that is in part closer to the radially innermost position than to the radially outermost position.

The above configurations mean that the overall shape of each of the coils is thinner towards the common axis of the generator and wider towards the outer edge of the generator, as can be seen in the example shown in FIG. 4. When the coils are arranged sequentially around the common axis, having a shape that is wider towards the outside can advantageously improve the packing density of coils on the coil annulus. This maximises the amount of space on the coil annulus that is occupied by conductive material and thus configured to generate emf. The amount of emf generated for a given size of generator can therefore be increased.

Each coil of the generator, viewed in cross-section in a plane parallel to the plane of the coil shape 700, lies completely within an imaginary infinite wedge-shaped area which emanates from the common axis and has two straight wedge boundaries which touch the coil cross section on opposite sides. The coil cross-section may touch each wedge boundary at a single point or at multiple points or a range of points. In an embodiment, each of the two wedge boundaries is touched by the coil cross-section at a position having a radial distance from the common axis that is greater than the radial distance between the common axis and the midpoint of the radially innermost position 701 and the radially outermost position 702 of the shape 700. This means that each wedge boundary is touched by the coil cross section at a position more than halfway outward along the radial extent of the coil. This however does not exclude either wedge boundary from also being touched by the coil cross-section at a position less than halfway outward along the radial extent of the coil. This embodiment is advantageous in that it allows the coils to be placed around the common axis in a way that maximises the amount of space in the coil annulus that is occupied by coils and thus actively generates emf. This allows the emf generating capacity of the generator to be increased for a given size of generator. If the coils only touched the wedge boundaries close to the radially inner part of the coils, there could be substantial unused space between the coils towards the radially outer parts, and so the advantage of increasing emf generation for a given size of generator would not be realised to the same extent. For instance, a coil having a stadium shape or an oval shape with two lines of symmetry would not fall under this embodiment, and would not allow for the maximization of coil annulus space dedicated to emf production as achieved by the present embodiment.

The first position 703a and second position 703b are on opposite sides of the shape, that is, the first and second positions (703a, 703b) are on opposite sides of an imaginary straight line 709 joining the radially innermost position 701 and the radially outermost position 702.

The shape 700 comprises a portion 710 that is radially outward from the first and second positions. The portion 710 joins the first position 703a the second position 703b. The portion 710 of the shape 700 is within an area 711 that is bounded by an inner line 712 and an outer line 713. The inner line 712 and outer line 713 are circular arcs that join the first position 703a and the second position 703b. The inner line and the outer line have the same radius of curvature 714, and the outer line has a greater length than the inner line. The radius of curvature 714 of the inner and outer lines is defined as a multiple of the separation 704 between the first and second positions (703a, 703b). In the case where the radius of curvature 714 is equal to 0.5 times the separation 704, the outer and inner lines would be semicircles. As the multiplier is increased above 0.5, the area 711 bounded by the inner line 712 and the outer line 713 becomes larger. So as to define an area 711 in which the advantages of the present disclosure over the prior art are present, the multiplier is greater than 0.5.

In other words, the area 711 in which the portion 710 exists is bounded by two circular arcs, both having the same radius of curvature. Both of the circular arcs have their two endpoints at the first and second positions. Both of the circular arcs are radially outward of the first and second positions. If the radius of curvature of the circular arcs were 0.5 times the linear separation of the first and second positions, then the two circular arcs would be identical semicircles and no finite area would be defined between them. Thus the multiplier is defined to be greater than 0.5 such that there exist two different circular arcs which satisfy the criteria defined. One circular arc is longer than and radially outward of the other, and the longer arc is defined as the outer line and the shorter arc is defined as the inner line. According to the disclosure, the area 711 is bounded by an inner line and outer line having a radius of curvature that is 0.625 times the separation 704. By reducing the multiplier towards 0.5, the area bounded by the inner line and outer line becomes narrower and approaches a semicircular arc which is the mathematical optimum shape of the portion 710. For instance, the area defined when the multiplier is 0.575 is contained entirely within the area defined when the multiplier is 0.625. Likewise, the area defined when the multiplier is 0.55 is contained entirely within the area defined when the multiplier is 0.575, and so on. Thus, more preferable embodiments of the disclosure have a multiplier of 0.575, 0.55, 0.52 or 0.51, each of which in turn narrows the area defined.

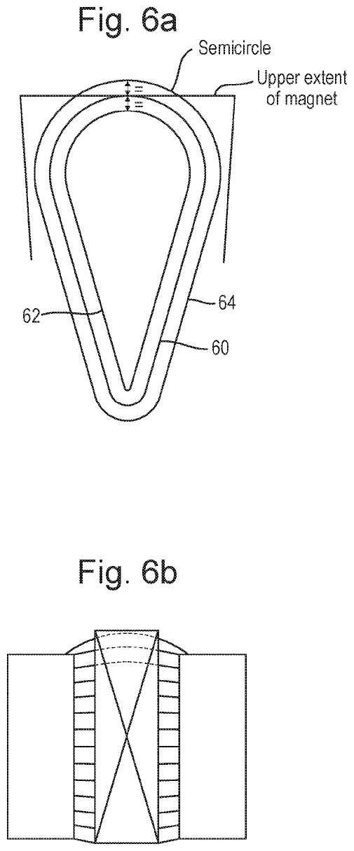

The inner line 712 and outer line 713 define an intermediate space (the area 711) in which the portion of the coil radially outward of the first and second positions falls. As noted above, the “shape” of the coil only refers to the path followed by the mid position of the coil winding (as shown by FIG. 6a where line 60 is the mid position and corresponds to the “shape” of the coil shown). This means that, while the shape of the coil radially outward of the first and second positions falls within the area 711, substantial parts of the coil itself (viewed in cross-section in a plane normal to the common axis) may fall outside said area. The mid position of the coil does fall within the area.

FIG. 7 shows a case of the area 711 in accordance with the disclosure, wherein the radius of curvature 714 of the first and second lines (712, 713) is equal to 0.625 times the separation 704.

As explained above, the optimum shape of the coil in the portion radially outward from the first and second points is a semicircle. In other words, for a given separation 704 of the first and second positions, the optimal configuration of the outer portion 710 is a curve with a radius of curvature 714 that is 0.5 times the separation 704. The area 711 of the present disclosure is bounded by inner and outer lines that have a radius of curvature of 0.625 times the separation 704, which represents a deviation from the optimum by 25%. Therefore, when the portion 710 that is radially outward of the first and second positions is within said area 711, it is considered to be within 25% of optimal performance.

Because the radius of curvature 714 of the curves defining the area 711 is 0.625 times the separation 704, this excludes the case where the portion 710 is a curve with a radius equal to the radius of the outer extent of the coil and the first and second portions 703a, 703b (i.e. the FIG. 3b case). Therefore, an increase in emf generated in the outer portion of the coil is necessarily achieved. More preferable embodiments have a radius of curvature 714 of 0.575 (within 15% of the optimum), more preferably 0.55 (within 10% of the optimum), more preferably 0.52 (within 4% of the optimum), more preferably 0.51 (within 2% of the optimum) times the separation 704. Reducing the multiplier towards 0.5 narrows the area 711 towards the optimum case of a semicircular portion 710 of the shape 700 and so generates more and more emf.

The first position 703a and second position 703b have a radial distance 705 from the common axis 800 that is greater than the radial distance 706 of the radially innermost position 701 from the common axis 800, by an amount 707 that is at least 60% of the difference 708 in radial distance from the common axis between the radially innermost position 701 and the radially outermost position 702. When the amount 707 is at least 60% of the difference 708, the shape 700 is wider toward its radially outer end than toward its radially inner end. This facilitates the packing of multiple coils in a sequence around the common axis, so as to maximise use of space by filling the stator annulus with coils which will be cut by lines of magnetic flux during rotation of the rotor. In preferable embodiments, the amount 707 is at least 70%, preferably at least 80%, more preferably at least 90% of the difference 708. Increasing the amount 707 as a percentage of the difference 708 facilitates the packing of a larger number of coils or coils with a greater length in the radial direction in the coil annulus, so as to generate a large emf in the axial flux generator.

The area 711 includes some circumferentially outer regions that would allow positions on opposite sides of the shape and at the same radial distance from the common axis to be radially further apart than the first position 703a and second position 703b (i.e. farther from the imaginary centre line 709 in a direction perpendicular to the radial direction). Some asymmetric shapes of the outer portion can extend into the circumferentially outer regions. In some embodiments, these circumferentially outer regions are excluded from the area 711, so that the area 711 is bounded by the inner line 712, the outer line 713, a straight line passing through the first position and parallel to the imaginary centre line 709, and a straight line passing through the second position and parallel to the imaginary line 709.

In some embodiments, the portion 710 of the shape 700 that is radially outward from the first and second positions (703a, 703b) that is within the area 711 bounded by the inner line 712 and the outer line 713 is at least 80%, preferably at least 90% of the length of the shape between the first and second positions. Such embodiments are advantageous because a large proportion of the section of the shape that joins the first position 703a and second position 703b at the radially outer end of the shape is contained within the area 711 shown above to increase emf generation, thereby improving the emf generation in that section further. In some embodiments all of the portion between the first and second positions 703a, 703b lies in the area 711.

In some embodiments, the shape 700 comprises a first radially extending portion 715a which ends from the first position 703a to the radially innermost position 701 and a second radially extending portion 715b which ends from the second position 703b to the radially innermost position 701. In an embodiment at least 60%, preferably at least 75% of the first and second radially extending portions are a straight line. In such an embodiment, the lateral sides of the coil, or at least the major portion of them, lie substantially parallel to a common radius of the generator's rotor or stator. The traversing lines of magnetic flux provided by the rotors then cut the turns of the coil orthogonally and thereby induce within them, in accordance with Fleming's right hand rule, the maximum possible emf. Such embodiments are advantageous in that a large proportion of the coil can be elongate in a radial direction of the generator. As explained above, in a section of the coil that is radial, lines of magnetic flux cut the coil orthogonally so as to maximise emf induction in that section.

In some embodiments of the disclosure, an angle formed between a tangent of the first radially extending portion 715a at the first position 703a and a tangent of the portion 710 of the shape that is radially outward from the first and second positions changes monotonically from the first position 703a with distance at which the tangent is taken along the portion 710 of the shape that is radially outward from the first and second positions. This concept is illustrated in FIG. 8, which shows a magnified view of a section of the shape 700 that includes the first position 703a. A first imaginary line 801 is tangential to the first radially extending portion 715a at the first position 703a. A second imaginary line 802 is tangential to the portion 710 of the coil that is radially outward from the first position and the second position, at an arbitrary point 802b, and forms angle 802a with the first imaginary line 801. According to the present embodiment, if arbitrary point 802b is moved an infinitesimal distance along the portion 710 of the shape that is radially outward from the first and second positions, away from the first position 703a (in the direction of arrow ‘A’ in FIG. 8), angle 802a cannot decrease, in other words it increases monotonically. This is true for any arbitrary point 802b that is on the portion 710 of the shape that is radially outward from the first and second positions. If FIG. 8 were drawn differently so that the relevant angle was the supplementary angle to angle 802b drawn in FIG. 8, then that angle would decrease monotonically with distance. In any case, the present embodiment requires that the relevant angle changes monotonically with distance along the portion 710 of the shape that is radially outward from the first and second positions. In other words, the portion 710 that is radially outward of the first and second positions has no point of inflection, meaning that the sign of the curvature (positive or negative) does not change along the portion 711. Such an embodiment has an advantageous effect wherein winding of the coil is facilitated because the portion 710 of the shape that is radially outward from the first and second positions only curves in one direction. Therefore the present embodiment can improve the efficiency of production of the coils.

In some embodiments, the angle formed between a tangent of the first radially extending portion 715a at the first position 703a and a tangent of the portion 710 of the shape that is radially outward from the first and second positions changes from the first position 703a as a continuous function with distance at which the tangent is taken along the portion 710 of the shape that is radially outward from the first and second positions. Referring again to FIG. 8, the present embodiment requires that, if arbitrary point 802b is moved an infinitesimal distance along the portion 710 of the shape that is radially outward from the first and second positions, the angle 802a formed between the tangents cannot experience a step change. Practically, this means that the portion 710 of the shape that is radially outward from the first and second positions does not have any sharp corners. This embodiment is advantageous in that it further facilitates winding of the coils, hence improving production efficiency.

In some embodiments, the first radially extending portion 715a is tangential at the first position 703a to the portion 710 of the shape that is radially outward from the first and second positions, and the second radially extending portion 715b is tangential at the second position 703b to the portion 710 of the coil that is radially outward from the first and second positions. Referring back to FIG. 8, in such an embodiment, as arbitrary point 802b approaches the first position 703a, the angle 802a formed between the tangents approaches zero. In this embodiment, the shape does not have a sharp corner at the first position 703a, and the same is also true at the second position 703b. This embodiment further facilitates winding of the coil and therefore has the advantageous effect of improving production efficiency.

In some embodiments, the portion 710 of the shape that is radially outward from the first and second positions is an elliptical arc. Such an embodiment means that emf generation of the coil in the portion 710 of the shape that is radially outward from the first and second positions will only fall to zero at infinitesimally small points where the shape is parallel to the circumferential direction of the axial flux generator. This embodiment is therefore advantageous in reducing the amount of the coil in its outermost portion that does not generate emf.

In some embodiments, the shape 700 has a single line of symmetry which is in the radial direction. The “radial direction” in this context refers to the direction of a radial line emanating from the common axis and passing through the midpoint of the first position and the second position of the shape of the coil. This facilitates close packing of multiple coils and optimises the amount of conductor in each coil that is cut by lines of magnetic flux in a direction perpendicular to the current. It is optimal for lines of magnetic flux to cut coils in a perpendicular direction, because this gives the shortest possible length of conductor (hence lowest possible resistance) for a given amount of flux to cut the conductor.

In an embodiment, the shape has no lines of symmetry in the plane of the shape other than the line of symmetry which is in the radial direction as described above. In such an embodiment, the shape is asymmetrical across a line that is perpendicular to that radial line of symmetry. Because the first position 703a and second position 703b are closer to the radially outermost position than to the radially innermost position, and are defined at a (e.g. any) point of maximum width of the shape, the coils having no mirror symmetry across a line perpendicular to the radial line of symmetry means that the coils are narrower at their radially inner ends than at their radially outer ends. This embodiment therefore allows the portion of space in the coil annulus which is occupied by coils to be increased when the sequence of coils is placed around the common axis. By increasing the space occupied by coils in the coil annulus, the emf generating capacity of the generator can be advantageously increased for a given size generator. Such an effect would not be achieved, for instance, by a generator having coils which have a stadium shape or an oval shape with two lines of symmetry (one being in the radial direction and the other being perpendicular to that radial direction). This embodiment has the further advantage of allowing sides of the coil to extend in a direction that is close to the optimum direction for emf generation (the optimum direction being a radial direction). For instance, in a coil having a stadium shape, the parallel long sides of that shape could not both extend in a radial direction or close to a radial direction, and thus the emf generation in these portions would be disadvantageously restricted.

In some embodiments, the coil annulus 15 has at least 5 coils, preferably at least 10 coils, and more preferably at least 15 coils. Increasing the number of coils on the coil annulus (within reason) has the advantageous effect of increasing the overall power that can be generated by the axial flux generator. Increasing the number of coils in the generator can also lead easily to multiphase generation and reducing the detrimental effect of cogging (see GB 2532478).

In some embodiments, the angle at the common axis 800 in the plane perpendicular to the common axis that is subtended by each of the coils is no more than 72°, preferably no more than 36°, more preferably no more than 24°. Restricting the angle subtended by each of the coils facilitates packing a greater number of coils in a sequence around the coil annulus 15. This facilitates multi-phase generation and reduced cogging as described above and in GB 2532478.

In some embodiments, each coil comprises a wound flat strip conductor as described in GB 2551364. By this means, a winding spiral is possible in which each layer rests exactly upon the preceding layer and thus the entire volumetric space for the coil is occupied by an electrical conductor. For specific types of conductor, a packing factor of virtually 100% is attainable, thus notably maximising electrical output. By contrast, specific winding difficulties pertaining to the winding of stator coils with conventional circular cross-section wire, can limit the true effective packing factor to as low as 78%. Further, using a flat strip conductor facilitates winding of the coil and thus improves production efficiency.

The primary choice of conductor for any motor or generator winding is copper, having the highest conductivity of any metal commonly available. And indeed, this is available in strip form and can be used for winding the stator coils of the above-described embodiment. Measures effective to insulate the copper strip include varnishing or using bare copper and then the interleaving of a plastics insulating strip as winding progresses.

An attractive alternative however, is the use of aluminium. Although not enjoying the same conductivity as copper, it has specific advantages over copper. The first being the fact that it is anodisable to effect insulation, that is the chemical changing at microscopic level of its surface to provide an insulating layer. Typically the thickness of such insulation is the order of a few microns, wholly insignificant in terms of influence on resistivity on a strip of thickness of say half of a millimeter (500 microns). The coils may therefore be formed from aluminium strip, anodized on one, or both sides. This is in important contrast to copper, where the use of insulating varnish, or an interleaved plastic strip does have a material impact on effective resistance per unit area.

Additional advantages that pertain to the use of aluminium as a conductor relate to density and cost. Aluminium is approximately half the density of copper, and by weight, half its cost (at 2016 prices). Thus a coil formed from aluminium strip can cost potentially one quarter of the equivalent copper coil. The provision of extra stator coils, specifically 20% more in number, to compensate for reduced electrical output due to the higher resistivity of aluminium relative to copper is dwarfed by the overall materials cost and weight savings.

One other factor relates to heat density. Coils formed from aluminium strip can operate and survive at far higher temperatures than copper. This de-sensitises cooling issues, and affords greater long term reliability.

In some embodiments, all of the coils of the coil annulus have substantially the same shape. This facilitates a regular sequence of coils around the common axis 800 so that emf generation by the axial flux generator can be maximised. This also facilitates multi-phase power generation, a reduction in cogging and smooth running of the generator as described above. Further, if all of the coils have substantially the same shape, ease of manufacture and assembly is increased.

In some embodiments, the radially outermost points of all of the coils of the coil annulus have substantially the same radial distance from the common axis. This embodiment reduces the amount of space on the coil annulus that is wasted by not carrying a coil. The amount of material used to build the generator for a given emf generation can thereby be reduced.

In practice, other design considerations may have to be taken into account such as the weight and cost of the magnets creating the field. Some compromise may be expeditious.

In some embodiments, the radially outermost extent of each of the magnetic annuli reaches a radial distance from the common axis that is greater than the radial distance from the common axis of the midpoint of the first and second positions, by an amount that is at least 50% of the difference in radial distance from the common axis between the radially outermost position and the midpoint of the first and second positions of the shape. In practice this means that a substantial amount of the length of the coil in the portion 710 that is radially outward from the first and second positions is placed in a position that is linearly between two magnets, and is therefore cut by magnetic field lines during operation. This provides the advantage of enabling much of the portion 710 to contribute to emf production. By contrast, a generator in which the portions of the coils radially outward of the first and second positions as defined herein are largely not placed in between magnets (such that the radially outermost extent of the magnets does not reach the radial distance from the common axis required by this embodiment) would not have a substantial contribution to emf production coming from the outer portions 710 of its coils.

In some embodiments, the magnetic annuli each hold a series of permanent magnets around the common axis, the permanent magnets defining the magnetic fields, wherein a radially outermost extent of each of the permanent magnets is no greater than a radially outermost extent of each of the coils.

In some embodiments, the radially outermost extent of each of the permanent magnets reaches at least 10% across a thickness of the radially outermost extent of the coils, the thickness being the radial distance between inner and outer perimeters of the coil. This has the advantage of enabling the portion 710 that is radially outward from the first and second positions of the shape of the coil to contribute substantially to emf generation as it is cut by magnetic field lines in operation of the generator.

The “inner perimeter” refers to the innermost boundary of the coil in a cross section in a plane parallel to the shape 700 of the coil. The “outer perimeter” refers to the outermost boundary of the coil in a cross section in a plane parallel to the shape 700. As shown in FIG. 6a, the outer perimeter 64 fully encompasses the inner perimeter 62.

The “thickness of the radially outermost extent” of a particular coil is the linear separation (in a radial direction) between the point on the outer perimeter which is closest to the radially outermost position 702, and the point on the inner perimeter which is closest to the radially outermost position 702. If all of the coils have the same radius of their radially outermost position 702, then the “thickness of the radially outermost extent of the coils” is the thickness of the radially outermost extent of any of the coils. If different coils have radially outermost positions at different radii, then the “thickness of the radially outermost extent of the coils” is taken to be the thickness of the radially outermost extent of the coil which reaches the greatest radial distance from the common axis (termed the “outermost coil”).

In some embodiments, each magnet reaches a maximum radial distance from the common axis that is greater than the radial distance from the common axis of the point on the inner perimeter of the outermost coil (which may be all of the coils) that is closest to the radially outermost position of that coil, by an amount which is at least 10% of the distance between the points on the inner perimeter and outer perimeter of that coil that are both closest to the radially outermost position 702 of the shape 700 of that coil. As mentioned, this has the advantage of enabling the portion 710 that is radially outward from the first and second positions of the shape of the coil to contribute substantially to emf generation as it is cut by magnetic field lines in operation of the generator.

The radially outermost extent of each of the permanent magnets preferably reaches at least 30%, more preferably at least 40% across the thickness of the radially outermost extent of the coils, so as further to increase the contribution to emf generation achieved by the portion 710 of the coil that is radially outwards from the first and second positions of the shape.

Preferably, the radially outermost extent of each of the permanent magnets reaches at most 100% across a thickness of the radially outermost extent of the coils. Increasing the radial extent of the magnets beyond this point would not substantially increase the emf generating capacity of the generator because there would be no coils axially aligned with the outermost parts of the magnets. So, by limiting the radial extent of the magnets to at most 100% across the thickness of the radially outermost extent of the coils in this way, a substantial saving in weight and materials for construction of the generator can be achieved without sacrificing emf production. Due to natural fringing effects, the maximum radial extent of the magnets may be further reduced so as to save even more weight/materials without substantially sacrificing emf generation. Thus, preferably, the radially outermost extent of each of the permanent magnets reaches at most 80%, more preferably at most 60% across a thickness of the radially outermost extent of the coils.

An example of this is shown in FIG. 6. In this case, as shown at FIG. 6a, the permanent magnets do not reach all the way to the top of the coil. Instead they reach approximately half way (i.e. 50%) across the top portion (thickness) of the coil. Due to natural fringing effects, as shown at FIG. 6b, quite a proportion of flux still cuts the top portion of the coil, effective to generate emf therein. The overall design of the magnets and coils to optimise output at the minimum weight and cost, can be determined by contemporarily available Finite Element Analysis (FEA) software.

The present disclosure described above relates to improving emf generation in the radially outermost part of each of the coils of an axial flux generator. The rest of the shape of the coil is not limited. The radially outer portion defined in claim 1 gives improved emf generation over examples of the prior art such as those shown in FIGS. 3a and 3b. Applying the features of the outer portion of the coil of the present disclosure to any coil in an axial flux generator will result in an improvement in emf generation in said outer portion, irrespective of the shape of the rest of the coil.

Although the disclosure has been described above with reference to the radially outer portion of the coil, the principles can equally be applied to the radially inner portion of the coil, even though the effect here is smaller because of the shorter length of that portion. In an embodiment, the radially inner portion comprises a semicircle. In another embodiment, where the shape of the coil comprises first and second radially extending portions that are straight lines, and first and second radially inner positions that are at the radially inner ends of the first and second radially extending portions respectively, the portion of the shape that is radially inward from the first and second radially inner positions is a curve that is within an inner area bounded by a first inner line and a second inner line, each of which have a radius of curvature that is 0.625 times the straight-line separation of the first and second inner positions, the second inner line being longer than the first inner line.

A method for designing a magnetic annuli and coil annulus of an axial flux generator in accordance with the present disclosure comprises: designing a shape of a radially outer portion of the coils and a radially outer magnetic profile of the magnetic fields on the basis of mathematical analysis (e.g. finite element analysis) so as to maximise electromotive force generated in the radially outer portion of the coils. The designing of the shape of the radially outer portion of the coils may comprise running a software program that performs finite element analysis to determine the shape that maximises emf output at the minimum weight and/or cost, and designing the shape of the radially outer portion on the basis of that determined shape.

1. An axial flux generator comprising:
two magnetic annuli;
a coil annulus;
the magnetic annuli and coil annulus having a common axis;
the two magnetic annuli defining a plurality of magnetic fields around the common axis extending across a gap between the two magnetic annuli and the coil annulus having a sequence of coils around the common axis in the gap such that the lines of magnetic flux from the magnetic fields cut the turns of the coils and this induces electric current in the coils as the magnetic annuli are caused to rotate relative to the coil annulus; wherein
each coil has a shape in a plane perpendicular to the common axis where a first position and a second position on the shape are at a radial distance from the common axis that is greater than the radial distance from the common axis of a radially innermost position of the shape by an amount that is at least 60% of the difference in radial distance from the common axis between the radially innermost position and a radially outermost position of the shape and the first position and second position are on opposite sides of the shape at a radial location where the shape has a maximum dimension in a direction perpendicular to the radial direction, and
a portion of the shape that is radially outward from the first and second positions is within an area bounded by an inner line and an outer line between the first and second positions, the inner line and the outer line both being radially outward from the first and second positions and having a radius that is 0.625 times the maximum dimension of the shape in the direction perpendicular to the radial direction, and the outer line being longer than the inner line.

2. An axial flux generator according to claim 1, wherein the portion of the shape that is radially outward from the first and second positions is within an area bounded by an inner line and an outer line between the first and second positions, the inner line and the outer line both being radially outward from the first and second positions and having a radius that is 0.51 times the maximum dimension of the shape in the direction perpendicular to the radial direction, and the outer line being longer than the inner line.

3. An axial flux generator according to claim 1, wherein the first position and the second position on the shape are at a radial distance from the common axis that is greater than the radial distance from the common axis of a radially innermost position of the shape by an amount that is at least 70% of the difference in radial distance from the common axis between the radially innermost position and a radially outermost position of the shape.

4. An axial flux generator according to claim 1, wherein the portion of the shape that is radially outward from the first and second positions is within the area bounded by an inner line and an outer line between the first and second positions, is at least 80% of the length of the shape between the first and second positions.

5. The axial flux generator according to claim 1, wherein the shape comprises a first radially extending portion which ends from the first position to the radially innermost position and a second radially extending portion which ends from the second position to the radially innermost position, wherein at least 60% of the first and second radially extending portions are a straight line.

6. The axial flux generator according to claim 5, wherein an angle formed between a tangent of the first radially extending portion at the first position and a tangent of the portion of the shape that is radially outward from the first and second positions changes monotonically from the first position with distance at which the tangent is taken along the portion of the shape that is radially outward from the first and second positions.

7. The axial flux generator according to claim 5 wherein an angle formed between a tangent of the first radially extending portion at the first position and a tangent of the portion of the shape that is radially outward from the first and second positions changes from the first position as a continuous function with distance at which the tangent is taken along the portion of the shape that is radially outward from the first and second positions.

8. The axial flux generator according to claim 5, wherein the first radially extending portion is tangential at the first position to the portion of the shape that is radially outward from the first and second positions, and wherein the second radially extending portion is tangential at the second position to the portion of the coil that is radially outward from the first and second positions.

9. The axial flux generator according to claim 1, wherein for each coil
the portion of the shape that is radially outward from the first and second positions is an elliptical arc.

10-15. (canceled)

16. The axial flux generator according to claim 1, wherein the magnetic annuli each hold a series of permanent magnets around the common axis, the permanent magnets defining the magnetic fields, wherein a radially outermost extent of each of the permanent magnets is no greater than a radially outermost extent of each of the coils.

17. The axial flux generator according to claim 16, wherein the radially outermost extent of each of the permanent magnets reaches at least 10% across a thickness of the radially outermost extent of the coils, the thickness being the radial distance between inner and outer perimeters of the coil.

18. The axial flux generator according to claim 16, wherein:
the radially outermost extent of each of the permanent magnets reaches at least 30%₇ across the thickness of the radially outermost extent of the coils; and/or
the radially outermost extent of each of the permanent magnets reaches at most 100%₇ across the thickness of the radially outermost extent of the coils.

19. The axial flux generator according to claim 16, wherein the radially outermost extent of each of the permanent magnets is 50% across a thickness of the radially outermost extent of the coils, the thickness being the radial distance between inner and outer perimeters of the coil.

20. (canceled)

21. The axial flux generator according to claim 1, wherein adjacent coils in the sequence of coils are non-overlapping in an axial direction.

22. The axial flux generator according to claim 1, wherein the radially outermost extent of each of the magnetic annuli reaches a radial distance from the common axis that is greater than the radial distance from the common axis of a midpoint of the first and second positions, by an amount that is at least 50% of the difference in radial distance from the common axis between the radially outermost position of the shape and the midpoint of the first and second positions of the shape.

23. The axial flux generator according to claim 1, wherein a separation between the first and second positions in a first direction perpendicular to the radial direction is greater than the separation in a direction parallel to the first direction of any other two points on the shape.

24. The axial flux generator according to claim 1, wherein for every pair of positions on the shape that are at a radial location where the shape has a maximum dimension in a direction perpendicular to the radial direction, the radial distance from the common axis of the midpoint of that pair of positions is greater than the radial distance from the common axis of the radially innermost position of the shape by an amount that is at least 60% of the difference in radial distance from the common axis of between the radially innermost position of the shape and the radially outermost position of the shape.

25. The axial flux generator according to claim 1, wherein each coil has a cross-section in a plane parallel to the shape of the coil which lies completely within an imaginary infinite wedge-shaped area which emanates from the common axis and has two straight wedge boundaries which touch the coil cross section on opposite sides, and wherein each of the two wedge boundaries touches the coil cross-section at a position having a radial distance from the common axis that is greater than the radial distance between the common axis and the midpoint of the radially innermost position and the radially outermost position of the shape.

26-27. (canceled)

28. A method of designing a magnetic annuli and coil annulus of an axial flux generator comprising: two magnetic annuli; a coil annulus; the magnetic annuli and coil annulus having a common axis; the two magnetic annuli defining a plurality of magnetic fields around the common axis extending across a gap between the two magnetic annuli and the coil annulus having a sequence of coils around the common axis in the gap such that the lines of magnetic flux from the magnetic fields cut the turns of the coils and this induces electric current in the coils as the magnetic annuli are caused to rotate relative to the coil annulus; wherein the method comprises:
designing a shape of a radially outer portion of the coils and a radially outer magnetic profile of the magnetic fields on the basis of finite element analysis so as to maximise electromotive force generated in the radially outer portion of the coils.

29. A method of making two magnetic annuli and a coil annulus, the magnetic annuli and coil annulus being constructed and arranged such as to have a common axis and such that the two magnetic annuli define a plurality of magnetic fields around the common axis extending across a gap between the two magnetic annuli and the coil annulus having a sequence of coils around the common axis in the gap such that the lines of magnetic flux from the magnetic fields cut the turns of the coils and this induces electric current in the coils as the magnetic annuli are caused to rotate relative to the coil annulus, the method comprising: making the outer portion of the coils and the magnetic fields with the shape and profile respectively of the method of claim 28.

30. (canceled)
